(19) United States
(12) Patent Application Publication
(10) Pub. No.: US 2005/0000345 A1
(43) Pub. Date: Jan. 6, 2005

(54) Blind trimming apparatus and method of trimming blinds

(76) Inventor: William J. Schimmels, Oconomowoc, WI (US)

Correspondence Address: MICHAEL BEST & FRIEDRICH, LLP, 100 E WISCONSIN AVENUE, MILWAUKEE, WI, 53202, US

(21) Appl. No.: 10/610,686

(22) Filed: Jul. 1, 2003

(51) Int. Cl. B26D 1/03

(52) U.S. Cl. 83/633; 83/694

(57) ABSTRACT

A blind trimming apparatus includes a frame defining a cutting recess, a cutting tool supported by the frame and extending into the cutting recess, and a cutting blade supported by the frame and moveable across the cutting tool during trimming. One of the cutting blade and the cutting tool includes a locating protrusion and the other of the cutting blade and the cutting tool defines a locating recess. The locating protrusion is engageable in the locating recess to index one of the cutting blade and the cutting tool with respect to the other of the cutting blade and the cutting tool.

### FIELD OF THE INVENTION

The present invention relates to an apparatus and a method of trimming blinds.

### BACKGROUND OF THE INVENTION

Conventional blinds generally include a headrail, a bottom rail, two or more ladders extending between the headrail and bottom rail, and a number of slats supported by the ladders. Conventional windows are generally manufactured in a number of nonstandard sizes. Therefore, blinds often are custom made to fit specific windows. Alternatively, blinds can be manufactured in a number of standard sizes and can be trimmed to fit specific windows. In these cases, a blind trimming apparatus is commonly used to trim one or more of the headrail, the bottom rail, and the slats.

A conventional blind trimming apparatus generally includes one or more pairs of opposable cutting blades. The blades are generally moved into engagement to cut the headrail, the bottom rail, and/or the slats.

### SUMMARY OF THE INVENTION

For a conventional blind trimming apparatus to operate effectively, the spacing between the pairs of opposable cutting dies must be maintained within a relatively narrow tolerance. Accordingly, setting up and adjusting the opposable cutting dies is generally difficult and can only be done at a high cost by skilled machinists.

During operation, the cutting dies become worn, nicked and/or damaged and occasionally must be replaced and/or repaired. Blade replacement and/or blade repair is also a difficult and time-consuming process that can only be performed by highly trained and skilled machinists.

In one embodiment, the invention provides a blind trimming apparatus including a frame defining a cutting recess, a cutting tool supported by the frame and extending into the cutting recess, and a cutting blade supported by the frame and moveable across the cutting tool during trimming. One of the cutting tool and the cutting blade includes a locating protrusion and the other of the cutting tool and the cutting blade defines a locating recess. The locating protrusion is engageable in the locating recess to index one of the cutting blade and the cutting tool with respect to the other of the cutting blade and the cutting tool.

In another embodiment, the invention provides a blind trimming apparatus including a frame defining a cutting recess, a cutting tool supported by the frame and extending into the cutting recess, a cutting blade moveable across the cutting tool during trimming, and an elastic member biasing one of the cutting blade and the cutting tool into shearing engagement with an other of the cutting blade and the cutting tool during trimming.

In another embodiment, the invention provides a blind trimming apparatus including a frame defining a cutting recess and having a rail and a carriage movable along the rail and supporting a cutting blade. The carriage is moveable along a cutting path and the cutting path is adjustable relative to the frame during trimming. The blind trimming apparatus also includes a cutting tool extending into the cutting recess and being engageable with the cutting blade as the carriage moves along the cutting path.

In another embodiment, the invention provides a blind trimming apparatus including a frame defining a cutting recess, and a cutting tool supported by the frame and extending into the cutting recess. The first cutting tool has a first hardness. The blind trimming apparatus also includes a cutting blade moveable across the cutting recess and engageable with the cutting tool during trimming to shear blinds against the cutting tool. The cutting blade has a second hardness and the second hardness is greater than the first hardness.

In another embodiment, the invention provides a blind trimming apparatus including a frame defining a cutting recess, a cutting tool supported by the frame and extending into the cutting recess, a cutting blade moveable along a cutting path and being engageable with the cutting tool during trimming to shear blinds against the cutting tool, and an insert positioned along the cutting path to support blinds during shearing.

The invention also provides a method of trimming blinds. The method includes providing a blind trimming apparatus including a frame defining a cutting recess, a cutting tool supported by the frame and extending into the cutting recess, and a carriage supporting a cutting blade and being moveable along a cutting path. The method includes moving the carriage along the cutting path in a direction generally toward the cutting tool, adjusting the cutting path relative to the frame to index the cutting blade and the cutting tool, and shearing at least a portion of the blinds between the cutting tool and the cutting blade.

Other independent features and independent advantages of the present invention will become apparent to those skilled in the art upon review of the following detailed description, claims, and drawings.

The present invention is further described with reference to the accompanying drawings, which show various constructions of the present invention. However, it should be noted that the invention is explained and illustrated by way of example only. The various elements and combinations of elements described below and illustrated in the drawings can be arranged and organized differently to result in constructions which are still within the spirit and scope of the present invention. Also, it is understood that the phraseology and terminology used herein is for the purpose of description and should not be regarded as limiting.

### BRIEF DESCRIPTION OF THE DRAWINGS

In the drawings, wherein like reference numerals indicate like parts:

FIGS. 1A and 1B are perspective views of a blind trimming apparatus, including a blade arrangement, embodying the invention.

FIG. 2 is an enlarged sectional view of the blind trimming apparatus taken along line II-II in FIG. 1B.

FIG. 2A is perspective view of a conventional venetian blind.

FIGS. 3A and 3B are enlarged perspective views of a portion of the blade arrangement shown in FIGS. 1A and 1B.

FIG. 4 is an enlarged perspective view of a portion of the blade arrangement shown in FIGS. 1A and 1B.

FIG. 5 is an enlarged perspective view of a portion of the blade arrangement shown in FIGS. 1A and 1B.

FIG. 6 is an enlarged perspective view of a portion of the blade arrangement shown in FIGS. 1A and 1B.

FIG. 7 illustrates a second construction of a blade arrangement for a blind trimming apparatus embodying the invention.

FIG. 8 is an enlarged perspective view of a portion of the blade arrangement shown in FIG. 7.

FIG. 9 is an enlarged perspective view of a portion of the blade arrangement shown in FIG. 7.

FIG. 10 is a perspective view of a third construction of a blade arrangement for a blind trimming apparatus embodying the invention.

FIG. 11 illustrates a fourth construction of a blade arrangement for a blind trimming apparatus embodying the invention.

FIG. 12 illustrates a fifth construction of a blade arrangement for a blind trimming apparatus embodying the invention.

FIG. 13 is an enlarged sectional view taken along line XIII-XIII in FIG. 12.

FIG. 14 illustrates a sixth construction of a blade arrangement for a blind trimming apparatus embodying the invention.

FIG. 15 is a sectional view taken along line XV-XV in FIG. 14.

FIG. 16 illustrates a seventh construction of a blade arrangement for a blind trimming apparatus embodying the invention.

FIG. 17 illustrates an eighth construction of a blade arrangement for a blind trimming apparatus embodying the invention.

### DETAILED DESCRIPTION

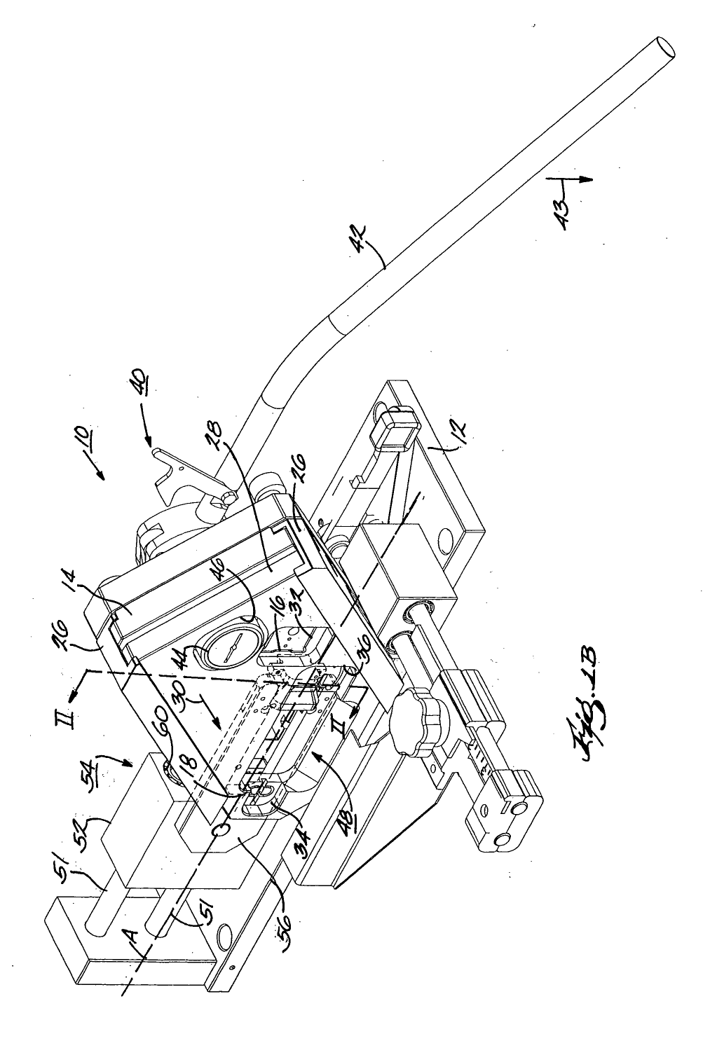

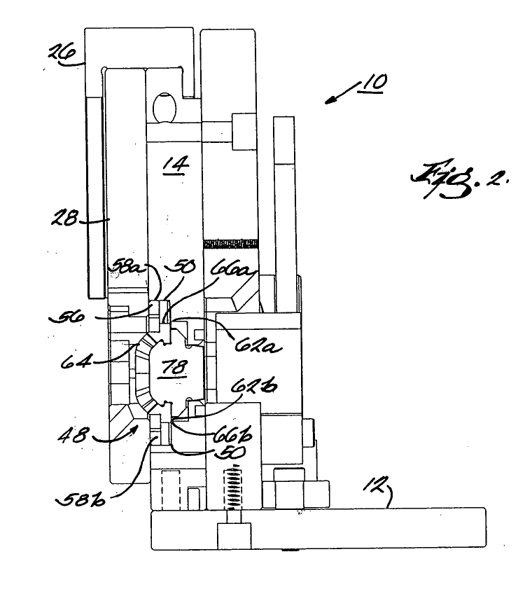

The drawings illustrate a blind trimming apparatus 10 which embodies the invention and which is adapted to trim a blind assembly V to length. FIG. 2A illustrates a conventional venetian blind V having a headrail H, a bottom rail R, three spaced-apart vertically extending ladders L, L′, L″ extending between the headrail H and bottom rail R, and a number of slats S supported by the ladders L, L′, L″. While the present invention is described herein as being used to trim venetian blinds V having a headrail H, a bottom rail R, and slats S in a single operation, one having ordinary skill in the art will appreciate that the present invention also can successfully be used to trim the individual elements or combinations of elements of the blinds (e.g., the bottom rail R, all of the slats S, individual slats S, and the headrail H). Additionally, one having ordinary skill in the art will appreciate that, while the invention is described herein as being operable to trim venetian blinds, the invention can also successfully be used to trim other window coverings.

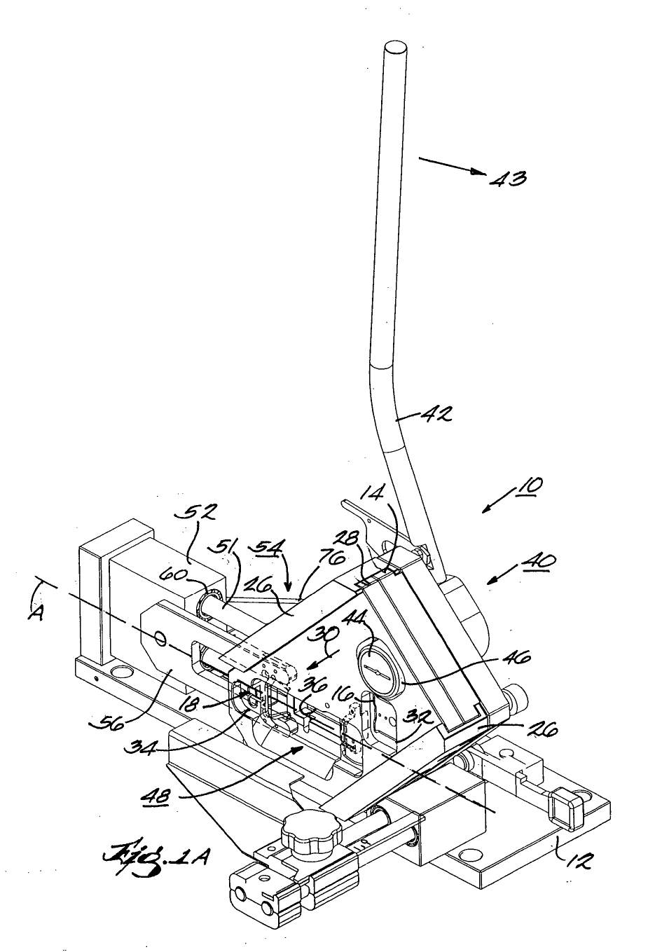

A blind trimming apparatus 10, embodying the invention is illustrated in FIGS. 1A, 1B, and 2. Portions of the apparatus 10 are similar to conventional blind trimming apparatus, such as those described in U.S. Pat. Nos. 5,806,394, 6,178,857, and 6,196,099 and Published U.S. patent application Ser. No. 2001/0054338, which are incorporated herein by reference.

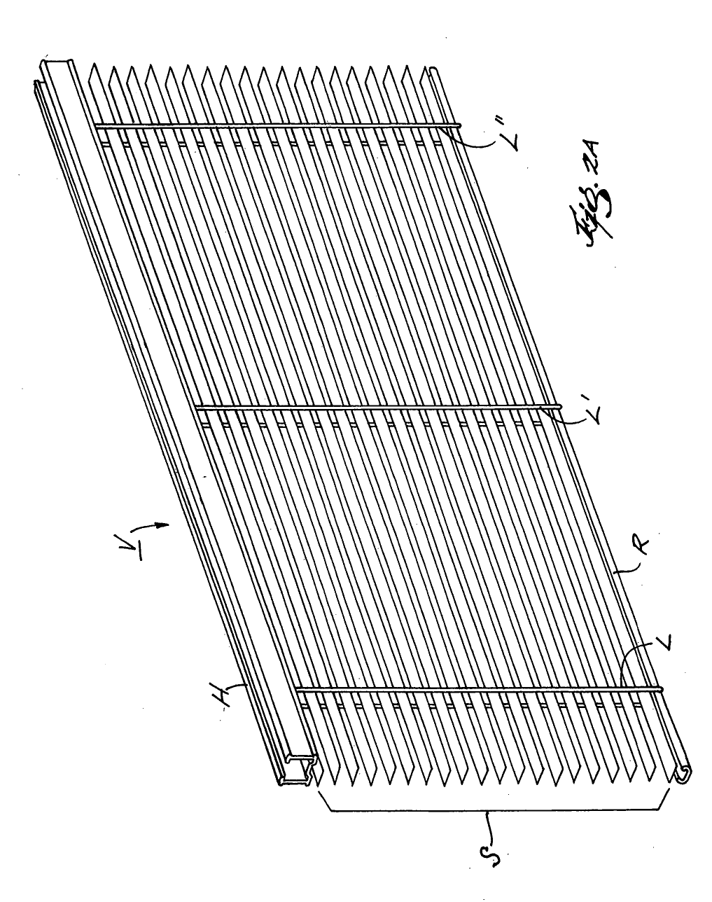

As shown in FIGS. 1A, 1B, 2, 3A, and 3B, the apparatus 10 includes a base plate 12 and a frame 14 fixed to and extending upwardly from the base plate 12. The frame 14 at least partially defines (FIG. 3A) a headrail opening 16 adapted to receive headrail H, a bottom rail opening 18 adapted to receive bottom rail R, and an elongated blind slat opening 20 adapted to receive slats S. A first axis A extends in a generally horizontal direction through the frame 14 and the blind slat opening 20.

As shown in FIGS. 1A, and 1B, guides or rails 26 extend along a face of the frame 14 and support a first carriage or die plate 28 for sliding movement in a direction substantially parallel to the rails 26 along a first cutting path 30 between a first retracted position (shown in FIG. 1A) and a first extended position (shown in FIG. 1B). The rails 26 are spaced-apart and extend along generally parallel axes at an angle of about 45 degrees with respect to axis A. In this manner, at least a portion of the first cutting path (represented by arrow 30 in FIGS. 1A and 1B) of the first carriage 28 is at an angle of about 45 degrees with respect to the first axis A. It would be readily understood, however, that the rails 26 can be successfully arranged differently to facilitate movement of the first carriage 28 along an arcuate path, a horizontal path, a vertical path, or otherwise to define the desired cutting path.

As shown in FIGS. 1A and 1B, the first carriage 28 defines a headrail recess 32, a bottom rail recess 34, and a central cutout 36. The headrail recess 32 and the bottom rail recess 34 are arranged to correspond with the locations of the headrail opening 16 and the bottom rail opening 18, respectively. As described in greater detail below, during trimming operations, a portion of a headrail H is inserted through the headrail opening 16 and into the headrail recess 32 and a bottom rail R is inserted through the bottom rail opening 18 and into the bottom rail recess 34. The first carriage 28 is then moved along the first cutting path 30 (i.e., in a generally downward path) laterally with respect to the frame 14 to shear the headrail H and the bottom rail R between the first carriage 28 and the frame 14.

The blind trimming apparatus 10 also includes a drive assembly 40 that is operable to move the first carriage 28 along the first cutting path 30. The drive assembly 40 includes a handle or lever 42 which is fixed to an eccentric cam 44 and which is operable to pivot the eccentric cam 44 into engagement with an aperture 46 in the first carriage 28. In this manner, when the handle 42 is pivoted downwardly (i.e., in the direction of arrow 43 in FIGS. 1A and 1B) from a first position (shown in FIG. 1A) to a second position (shown in FIG. 1B), the eccentric cam 44 pivots into engagement with a lower edge of the aperture 46, causing the first carriage 28 to move downwardly along the first cutting path 30 toward the first extended position. As the first carriage 28 moves along the first cutting path 30, the headrail H is sheared between the headrail opening 16 in the frame 14 and the headrail recess 32 in the first carriage 28 and the bottom rail R is sheared between the bottom rail opening 18 in the frame 14 and the bottom rail recess 34 in the first carriage 28. After the headrail H and bottom rail R are trimmed, the handle 42 can be returned from the second position to the first position to thereby also return the first carriage 28 to the retracted position.

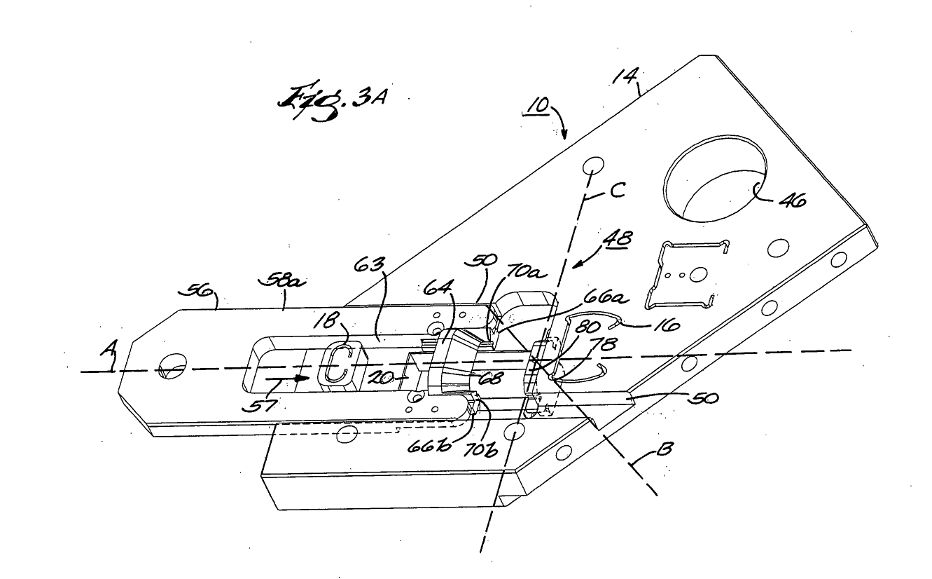

The blind trimming apparatus 10 also includes a blade arrangement 48 having a second carriage 56. As shown in FIGS. 2, 3A, 3B, and 4, the second carriage 56 is a substantially U-shaped member having forwardly extending spaced-apart legs 58a, 58b and defining an internal space 63 between the legs 58a, 58b. Forward ends of the legs 58a, 58b define blade recesses 62a, 62b (shown in FIGS. 2 and 4).

Guides or rails 50 (shown in FIGS. 2, 3A, and 3B) extend into the frame 14 and extend laterally along a surface of the frame 14 in a direction substantially parallel to the first axis A. The second carriage 56 is slideably mounted on the rails 50 for movement along a second cutting path (represented by arrow 57 in FIGS. 3A and 3B) extending between a second retracted position of the carriage 56 (shown in FIGS. 1A and 3A) and a second extended position of the carriage 56 (shown in FIGS. 1B and 3B).

Additionally, the blind trimming apparatus 10 includes a second drive assembly 54 (shown in FIGS. 1A and 1B) that is operable to move the second carriage 56 between the second retracted position and the second extended position. As illustrated in FIGS. 1A and 1B, the drive assembly 54 includes two spaced-apart cylindrical rails 51 supported on the base plate 12, and the second carriage 56 is coupled to a follower 52 with two parallel through-holes 60. The rails 51 extend through the through-holes 60 in the follower 52 to guide movement of the second carriage 56 between the second retracted position and the second extended position.

The second drive assembly 54 also includes a connecting rod 76 (shown in FIG. 1A) operably connected to the first drive assembly 40 so that pivoting the handle 42 also moves the second carriage 56 between the second retracted position and the second extended position. In this manner, an operator can simultaneously move both the first and second carriages 28, 56 between their respective retracted and extended positions with a movement of a single handle 42. Of course, the first and second drive assemblies 40, 54 could be uncoupled and made to be independently operable so that the first and second carriages 28, 56 can be moved independently.

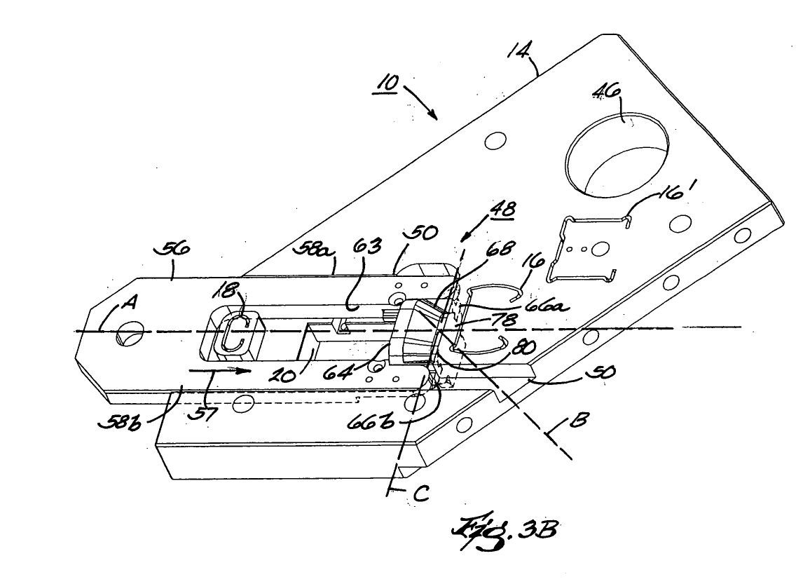

The blade arrangement 48 also includes a cutting blade 64, which is coupled to the forward ends of the legs 58a, 58b and extends across the internal space 63. In some aspects and in the illustrated construction, the cutting blade 64 includes laterally extending flanges 66a, 66b and an arcuately shaped cutting edge 68 extending between the flanges 66a, 66b. As shown in FIGS. 3A, 3B, and 5, the flanges 66a, 66b are configured to be received in and closely engage the blade recesses 62a, 62b of the second carriage 56. Forward portions 69a, 69b of the flanges 66a, 66b extend outwardly from the leading edge of the cutting blade 64 a short distance (e.g., between about 0.10 inches and about 0.23 inches in the illustrated construction) beyond the cutting edge 68.

As shown in FIGS. 3A and 5, the flanges 66a, 66b define locating recesses 70a, 70b. In some aspects and in the illustrated construction, the locating recesses 70a, 70b are generally C-shaped notches located on interior sides (i.e., opening toward the interior space 63) and extend laterally through the flanges 66a, 66b in a direction substantially parallel to the first axis A. However, while not shown, the recesses 70a, 70b can be located in other positions on one or both of the legs 58a, 58b of the second carriage 56 and/or on the cutting blade 64. In some aspects and in the illustrated construction, forward ends of the locating recesses 70a, 70b open through the forward portions 69a, 69b of the flanges 66a, 66b. In this manner, the forward ends of the locating recesses 70a, 70b are spaced a short distance from the cutting edge 68 along the first axis A.

During trimming operations and over time, the cutting edge 68 can become nicked, dulled, and/or misshaped. To afford ready removal of the cutting blade 64 for maintenance and repair, the blade arrangement 48 also includes fasteners (not shown) which selectively and removeably fix the flanges 66a, 66b to the legs 58a, 58b. In this manner, when the cutting edge 68 is damaged, an operator can remove the cutting blade 64 for sharpening, or alternatively, an operator can replace the damaged cutting blade 64.

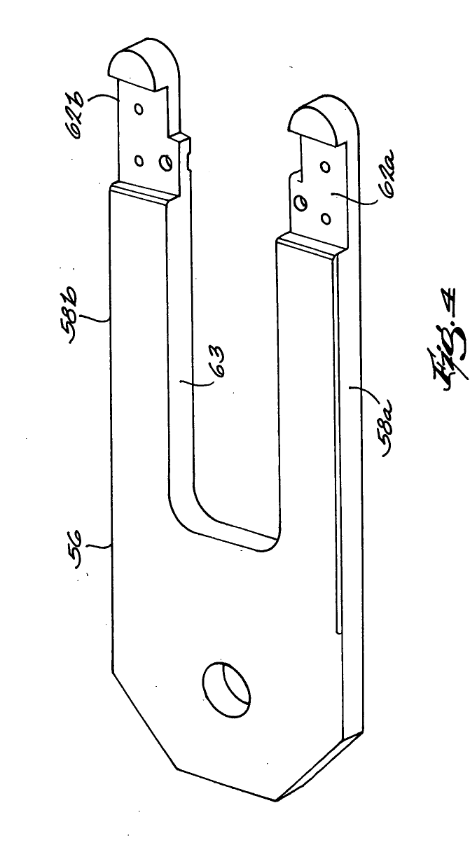

In the construction illustrated in FIG. 6, the cutting tool 78 includes a support flange 79 which extends outwardly from a rearward end of the cutting tool 78 and is configured to be received in a slotted recess (not shown) in the frame 14. The support flange 79 travels with the cutting tool 78 along the slotted recess in the frame 14 to accommodate movement of the cutting tool 78 during trimming operations. Additionally, the engagement between the support flange 79 and the slotted recess limits movement of the cutting tool 78 relative to the frame 14 within a desired travel area or path and prevents the cutting tool 78 from inadvertently becoming separated from the frame 14.

As shown in FIGS. 2, 3A, 3B, and 6, the blade arrangement 48 also includes a die or cutting tool 78, which extends outwardly from the frame 14 into the blind slat opening 20 and defines a second axis B that intersects the first axis A at an angle of approximately 90 degrees. The cutting tool 78 is moveably coupled to the frame 14 for movement along the second axis B. Additionally, in some aspects and in some constructions, the cutting tool 78 is moveably coupled to the frame 14 for movement along a third axis C, which is substantially perpendicular to the first and second axes A, B.

As shown in FIG. 6, the cutting tool 78 has a generally arcuately shaped cutting edge 80 that is shaped to correspond to the generally arcuately shaped cutting edge 68 of the cutting blade 64. More particularly, as described in detail below, the cutting edge 80 is arranged and shaped to closely engage the cutting edge 68 of the cutting blade 64 to shear portions of the blind slats S located in the blind slat opening 20. In other aspects and in other constructions (not shown), one or both of the cutting edges 68, 80 can have any other shape to provide different blind slat configurations (e.g., dog-eared, pointed, and the like) but are preferably similarly shaped to facilitate a shearing interaction during trimming operations.

Flanges 82a, 82b extend outwardly from the cutting tool 78 on opposite sides of the cutting edge 80 and include respective engagement surfaces 84a, 84b. Additionally as shown in FIG. 6, the cutting tool 78 includes two substantially pointed locating projections 86a, 86b. In other aspects and in other constructions (not shown), the cutting tool 78 can include one, three, or more locating projections 86a, 86b. Additionally, in other aspects and in other constructions (not shown), the locating projections 86a, 86b, can have other shapes and configurations (e.g., arcuate, dog-eared, T-shaped, and the like). As explained in greater detail below, the locating projections 86a, 86b are configured to matingly engage the locating recesses 70a, 70b on the cutting blade 64 to facilitate indexing of the cutting tool 78 with respect to the cutting blade 64.

During operation of the trimming apparatus 10, an operator moves the first and second carriages 28, 56 to the first and second retracted positions (as shown in FIG. 1A and as partially shown in FIG. 3A). The operator then inserts a length of the headrail H through the headrail opening 16 and into the headrail recess 32, a length of the bottom rail R through the bottom rail opening 18 and into the bottom rail recess 34, and the blind slats S into the blind slat opening 20 and the central cutout 36.

The operator then operates the first and second drive assemblies 40, 54 to move the first and second carriages 28, 56. In particular, the operator pivots the handle 42 (e.g., in a clockwise direction as represented by arrow 43 in FIGS. 1A and 1B), moving the first and second carriages 28, 56 along the first and second cutting paths 30, 57, respectively. As described above, as the first carriage 28 moves along the first cutting path 30 and cooperates with the frame 14 to shear one or both of the headrail H and the bottom rail R.

As the second carriage 56 moves along the second cutting path 57, the cutting edge 68 of the cutting blade 64 engages individual slats S located in the blind slat opening 20. Lateral motion of the cutting blade 64 causes the cutting edge 68 to cut through or trim the individual slats S. As shown in FIGS. 1B and 3B, as the second carriage 56 continues along the second cutting path 57, the cutting blade 64 approaches the cutting tool 78. As the second carriage 56 continues to move along the second cutting path 57, the forward ends of the locating recesses 70a, 70b move into engagement with the locating projections 86a, 86b of the cutting tool 78. The engagement between the locating projections 86a, 86b and the locating recesses 70a, 70b causes the cutting tool 78 to move along the second axis B into engagement with the cutting blade 64.

Also or alternatively, in some constructions and in some aspects, the engagement between the locating recesses 70a, 70b and the locating projections 86a, 86b causes the cutting tool 78 to move along the third axis C into engagement with the cutting blade 64. More particularly, the engagement between the locating recesses 70a, 70b and the locating projections 86a, 86b indexes the cutting blade 64 and the cutting tool 78 so that as the cutting edge 68 of the cutting blade 64 passes across the cutting edge 80 of the cutting tool 78, the cutting edges 68, 80 are spaced-apart by a predetermined distance (e.g., between about 0.000 inches and about 0.001 inches). Movement of the cutting tool 78 along the second axis B is limited by the interaction between the engagement surfaces 84a, 84b and the flanges 66a, 66b so that the cutting edge 80 of the cutting tool 78 is preferably prevented from moving into locking engagement with the cutting blade 64.

Because the engagement between the cutting edges 68, 80 is so closely controlled, the last few slats S are sheared and are not bent or torn. Additionally, because the cutting tool 78 is indexed with respect to the cutting blade 64, set up and adjustment of the blind trimming apparatus 10 is relatively simple. More particularly, in some aspects and in some constructions, an operator is not required to closely calibrate the relative position of the cutting blade 64 and the cutting tool 78 during set up. Rather, cutting blade 64 and cutting tool 78 replacement is accomplished using conventional fasteners and often does not require shims or other adjustment and measuring apparatuses.

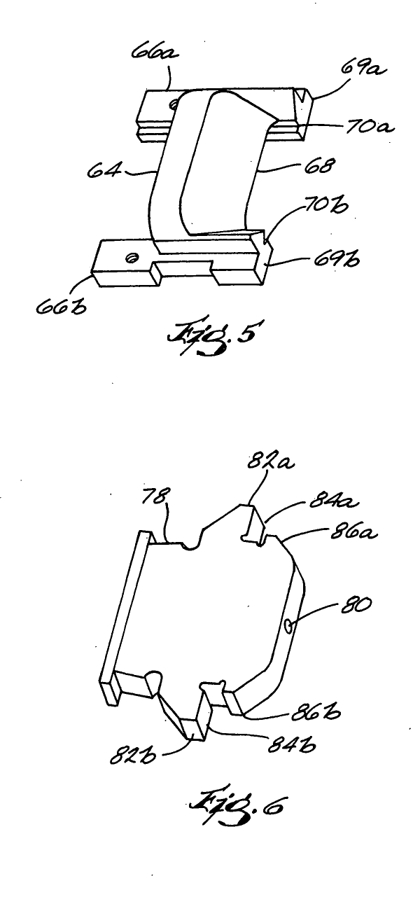

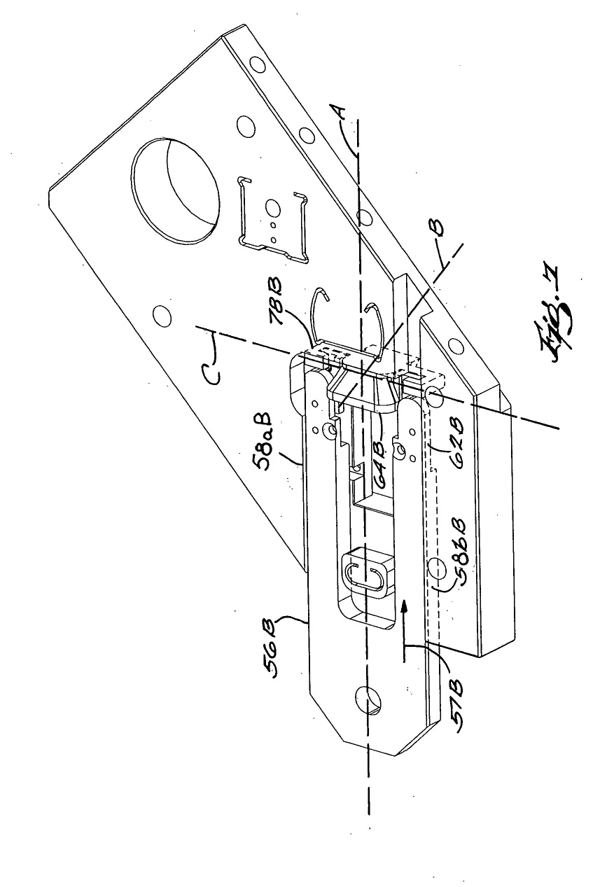

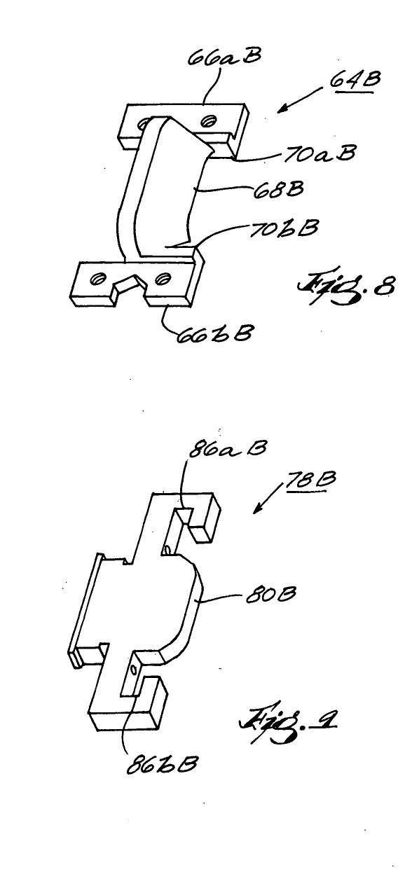

A second construction of a blade arrangement 48B for the blind trimming apparatus 10 is illustrated in FIGS. 7-9. Common elements are identified by the same reference number “B”.

As shown in FIG. 7, a carriage 56B is moveable along a cutting path (represented by arrow 57B in FIG. 7) which is substantially parallel to the first axis A. The carriage 56B supports a cutting blade 64B, having flanges 66aB, 66bB and a cutting edge 68B extending between the flanges 66aB, 66bB. In some aspects and in the illustrated construction, forwardly extending legs 58aB, 58bB of the carriage 56B define blade recesses 62B (only one is shown in FIG. 7) and the flanges 66aB, 66bB are positioned in the blade recesses 62B. Fasteners (not shown) removeably couple the flanges 66aB, 66bB to the carriage 56B and facilitate blade removal and blade replacement.

Interior sides of the flanges 66aB, 66bB provide locating projections 70aB, 70bB. In some aspects and in the construction illustrated in FIG. 7, the locating projections 70aB, 70bB are rectangularly shaped and extend laterally along the length of the flanges 66aB, 66bB. However, in other aspects and in other constructions (not shown), the locating projections 70aB, 70bB can have other shapes and configurations (e.g, dog-eared, T-shaped, pointed, arcuate, and the like).

The frame 14 supports a cutting tool 78B having a cutting edge 80B and defining locating recesses 86aB, 86bB located on opposite sides of the cutting edge 80B. In some aspects and in the illustrated construction, the locating recesses 86aB, 86bB are substantially rectangular and are configured to matingly engage the locating projections 70aB, 70bB of the cutting blade 64B.

During operation, as the carriage 56B is moved along the cutting path 57B (e.g., by a drive assembly, as described above with respect to the previously described first construction), the cutting edge 68B contacts and trims some of the slats S of the blinds V. As the carriage 56B continues to move along the cutting path 57B, forward ends of the flanges 66aB, 66bB contact the cutting tool 78B and the locating projections 70aB, 70bB are moved into engagement with the locating recesses 86aB, 86bB. The engagement between the locating projections 70aB, 70bB and the locating recesses 86aB, 86bB causes the cutting tool 78B to move along the second axis B so that the cutting edges 68B, 80B are spaced-apart a predetermined distance along the second axis B. Alternatively or in addition, the engagement between the locating recesses 86aB, 86bB and the locating projections 70aB, 70bB causes the cutting tool 78B to move along the third axis C so that the cutting edges 68B and 80B are spaced-apart a predetermined distance along the third axis C.

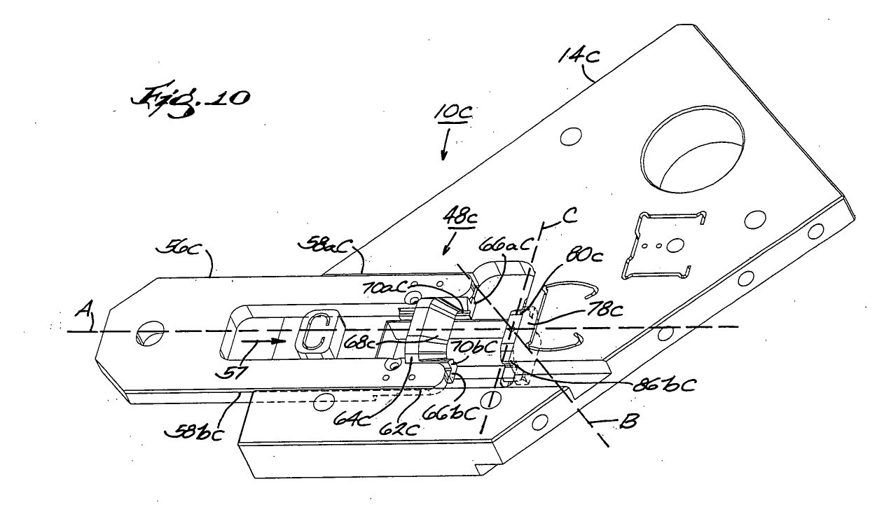

A third construction of a blade arrangement 48C for a blind trimming apparatus 10 is illustrated in FIG. 10. Common elements are identified by the same reference number “C”.

As shown in FIG. 10, a carriage 56C is moveable along a cutting path (represented by arrow 57C) which is substantially parallel to the first axis A. The carriage 56C is preferably coupled to a drive assembly (not shown) which is substantially similar to the above-described drive assemblies. The carriage 56C supports a cutting blade 64C, having flanges 66aC, 66bC and a cutting edge 68C extending between the flanges 66aC, 66bC. In some aspects and in the illustrated construction, forwardly extending legs 58aC, 58bC of the carriage 56C define blade recesses 62C (only one is shown in FIG. 10) and the flanges 66aC, 66bC are positioned in the blade recesses 62C. Fasteners (not shown) removeably couple the flanges 66aC, 66bC to the carriage 56C and facilitate blade removal and blade replacement.

Interior sides of the flanges 66aC, 66bC define locating recesses 70aC, 70bC. In some aspects and in the illustrated construction, the locating recesses 70aC, 70bC are arcuately shaped and extend laterally through the length of the flanges 66aC, 66bC. However, in other aspects and in other constructions (not shown), the locating recesses 70aC, 70bC can have other shapes and configurations (e.g, dog-eared, T-shaped, pointed, and the like).

The frame 14 supports a cutting tool 78C having a cutting edge 80C and providing locating projections 86aC, 86bC located on opposite sides of the cutting edge 80C. In some aspects and in the illustrated construction, the locating projections 86aC, 86bC are substantially arcuately shaped and are configured to matingly engage the locating recesses 70aC, 70bC of the cutting blade 64C.

During operation, as the carriage 56C is moved along the cutting path 57C (e.g., by a drive assembly, as described above with respect to the previously described first construction), the cutting edge 68C contacts and trims some of the slats S of the blinds V. As the carriage 56C continues to move along the cutting path 57C, forward ends of the flanges 66aC, 66bC contact the cutting tool 78C and the locating projections 86aC, 86bC are moved into engagement with the locating recesses 70aC, 70bC. The engagement between the locating projections 86aC, 86bC and the locating recesses 70aC, 70bC causes the cutting blade 64C and/or the carriage 56C to move along the second axis B so that the cutting edges 68C and 80C are spaced-apart a predetermined distance along the second axis B. Alternatively or in addition, the engagement between the locating projections 86aC, 86bC and the locating recesses 70aC, 70bC causes the cutting blade 64C and/or the carriage 56C to move along the third axis C so that the cutting edges 68B and 80B are spaced-apart a predetermined distance along the third axis C.

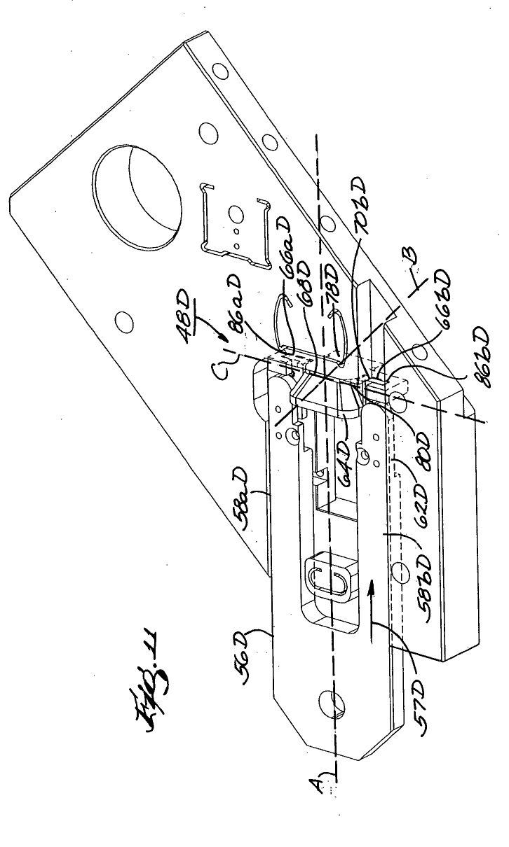

A fourth construction of a blade arrangement 48D for a blind trimming apparatus 10 is illustrated in FIG. 11. Common elements are identified by the same reference number “D”.

As shown in FIG. 11, a carriage 56D is moveable along a cutting path (represented by arrow 57D) which is substantially parallel to the first axis A. The carriage 56D is preferably coupled to a drive assembly (not shown) which is substantially similar to the above-described drive assemblies. The carriage 56D supports a cutting blade 64D, having flanges 66aD, 66bD and a cutting edge 68D extending between the flanges 66aD, 66bD. In some aspects and in the illustrated construction, forwardly extending legs 58aD, 58bD of the carriage 56D define blade recesses 62D (only one is shown in FIG. 11) and the flanges 66aD, 66bD are positioned in the blade recesses 62D. Fasteners (not shown) removeably couple the flanges 66aD, 66bD to the carriage 56D and facilitate blade removal and blade replacement.

Forward portions of the flanges 66aD, 66bD provide locating projections 70aD, 70bD. The frame 14 supports a cutting tool 78D having a cutting edge 80D and defining locating recesses 86aD, 86bD located on opposite sides of the cutting edge 80D.

During operation, as the carriage 56D is moved along the cutting path 57D (e.g., by a drive assembly, as described above with respect to the previously described first construction), the cutting edge 68D contacts and trims some of the slats S of the blinds V. As the carriage 56D continues to move along the cutting path 57D, forward ends of the flanges 66aD, 66bD contact the cutting tool 78D and the locating projections 70aB, 70bB are moved into engagement with the locating recesses 86aD, 86bD. The engagement between the locating projections 70aD, 70bD and the locating recesses 86aD, 86bD causes the cutting blade 64D and/or the carriage 56D to move along the second axis B so that the cutting edges 68D and 80D are spaced-apart a predetermined distance along the second axis B during trimming. Alternatively or in addition, the engagement between the locating projections 86aD, 86bD and the locating recesses 70aD, 70bD causes the cutting blade 64D and/or the carriage 56D to move along the third axis C so that the cutting edges 68D and 80D are spaced-apart a predetermined distance along the third axis C.

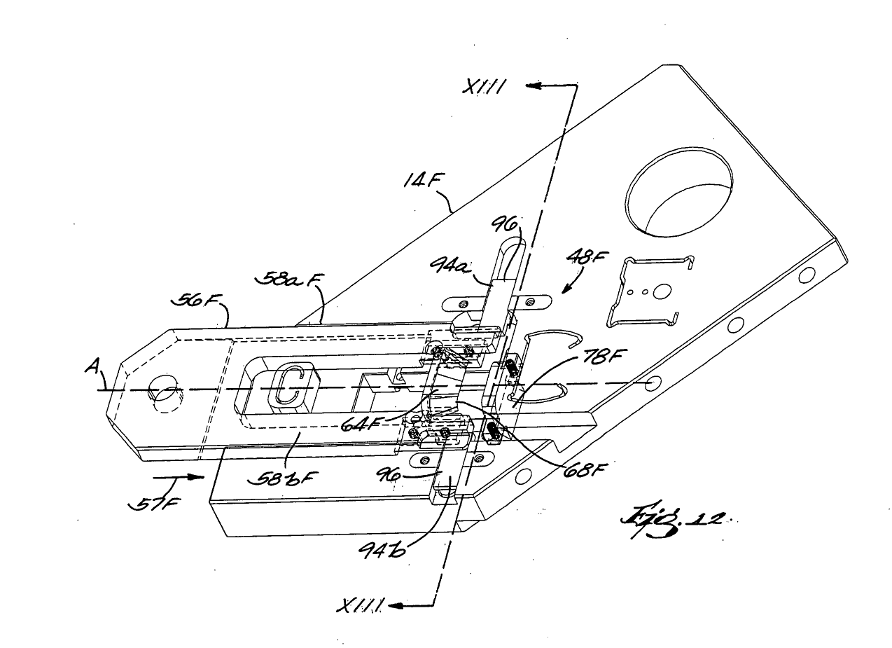

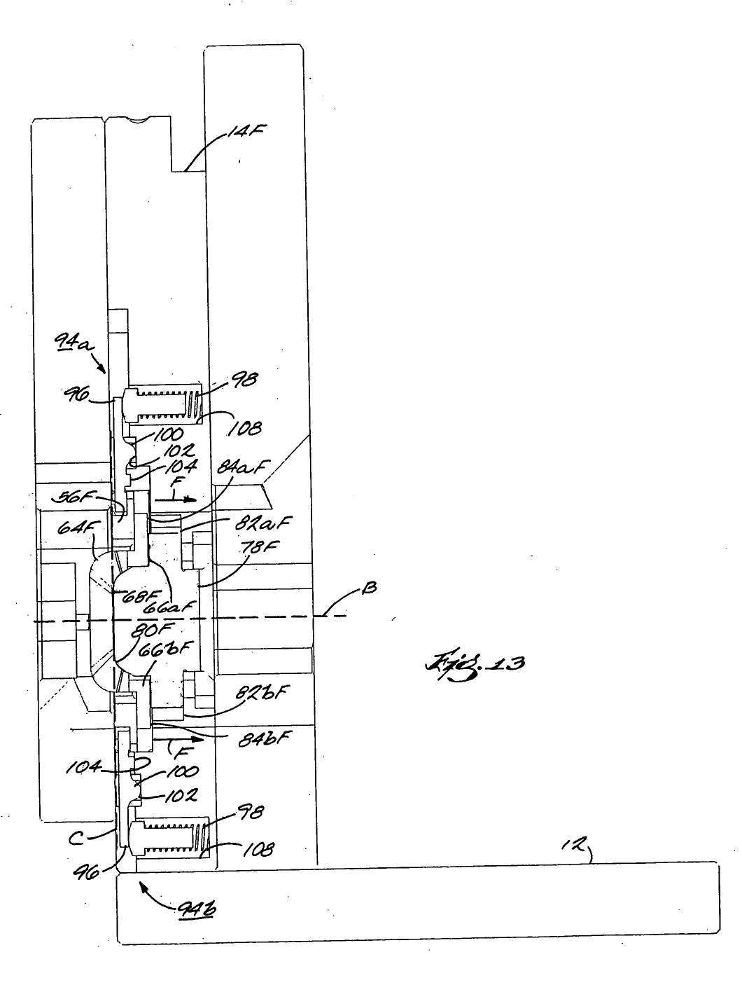

A fifth construction of a blade arrangement 48E for a blind trimming apparatus 10 is illustrated in FIGS. 12 and 13. Common elements are identified by the same reference number “F”.

As shown in FIGS. 12 and 13, a carriage 56F is moveable along a cutting path (represented by arrow 57F) which is substantially parallel to the first axis A. The carriage 56F is preferably coupled to a drive assembly (not shown) which is substantially similar to the above-described drive assemblies. The carriage 56F supports a cutting blade 64F, having flanges 66aF, 66bF and a cutting edge 68F extending between the flanges 66aF, 66bF. In the illustrated construction, forwardly extending legs 58aF, 58bF of the carriage 56F define blade recesses (not shown) and the flanges 66aF, 66bF are positioned in the blade recesses. Fasteners (not shown) removeably couple the flanges 66aF, 66bF to the carriage 56F and facilitate blade removal and blade replacement.

The frame 14F supports a cutting tool 78F having a cutting edge 80F and outwardly extending flanges 82aF, 82bF located on opposite sides of the cutting edge 80F. The flanges 82aF, 82bF define engagement surfaces 84aF, 84bF.

The blade arrangement 48F also includes biasing members 94a, 94b, which are positioned on opposite sides of the cutting path 57F and are operable to bias the carriage 56F and/or the cutting blade 64F into engagement with the cutting tool 78F. More particularly, the biasing members 94a, 94b are positioned along the first axis A and are operable to bias the cutting edge 68F of the cutting blade 64F into engagement with the cutting edge 80F of the cutting tool 78F.

In some aspects and in the construction illustrated in FIGS. 12 and 13, the biasing members 94a, 94b include pivot arms 96 and elastic members (e.g., springs) 98. The pivot arms 96 are elongated members, which extend along the frame 14 in a direction substantially parallel to the third axis C. The pivot arms 96 include pivot protrusions 100. Arcuately shaped portions of the pivot protrusions 100 extend into correspondingly contoured recesses 102 in the frame 14. The pivot arms 96 also include pivot limiting protrusions or pivot stops 104 that are located between the pivot protrusions 100 and distal ends and extend outwardly toward the frame 14. The pivot limiting protrusions 104 limit the pivoting movement of the pivot arms 96 in a first direction (e.g., in the construction illustrated in FIG. 13, the pivot limiting protrusions 104 limit pivoting movement toward the frame 14).

At least a portion of the springs (e.g., compression springs, leaf springs, helical springs, and the like) 98 are housed in recesses 108 in the frame 14 and extend outwardly from the frame 14 in a direction that is substantially parallel to the second axis B. The springs 98 engage distal ends of the pivot arms 96, causing the pivot arms 96 to pivot relative to the frame 14F

During operation, as the carriage 56F is moved along the cutting path 57F (e.g., by a drive assembly, as described above with respect to the previously described first construction), the cutting edge 68F contacts and trims some of the slats S of the blinds V. As the carriage 56F continues to move along the cutting path 57F, the pivot arms 96 contact the legs 58aF, 58bF and apply a force (represented by arrows F in FIG. 13) to the carriage 56F. The force F moves the carriage 56F and the cutting blade 64F in a direction substantially parallel to the second axis B and toward the cutting edge 80 of the cutting tool 78. More particularly, the pivot arms 96 move the carriage 56F and the cutting blade 64F into shearing engagement with the cutting edge 80F so that a desired distance is maintained between cutting edges 64F and 80F.

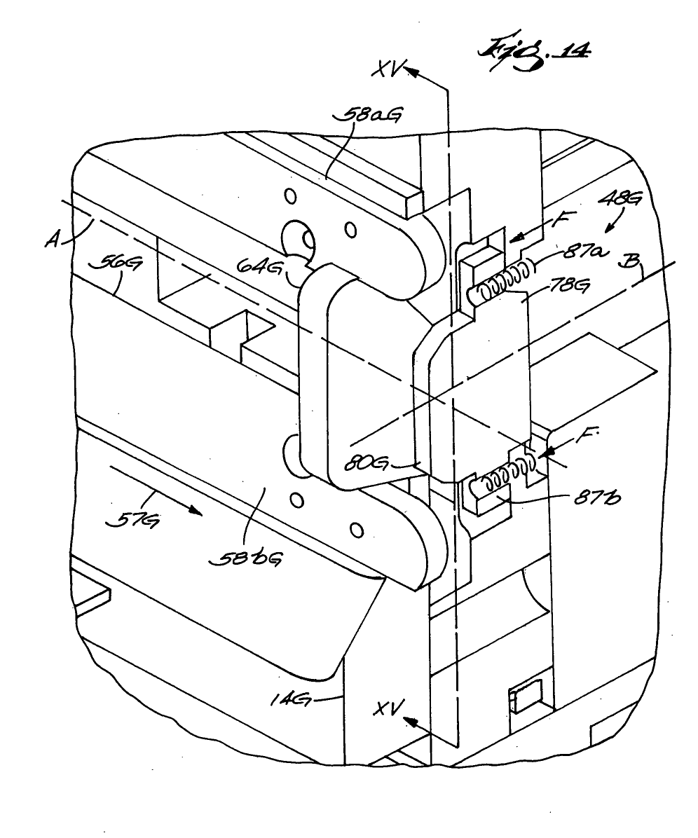

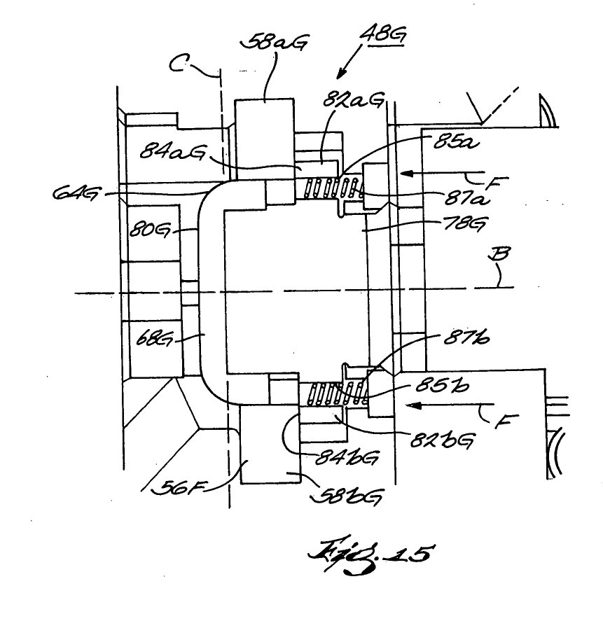

A sixth construction of a blade arrangement 48G for a blind trimming apparatus 10 is illustrated in FIGS. 14 and 15. Common elements are identified by the same reference number “G”.

As shown in FIGS. 14 and 15, a carriage 56G is moveable along a cutting path (represented by arrow 57G) which is substantially parallel to the first axis A. The carriage 56G is preferably coupled to a drive assembly (not shown) which is substantially similar to the above-described drive assemblies. The carriage 56G supports a cutting blade 64G, having outwardly extending flanges (not shown) and a cutting edge 68F extending between the flanges. In some aspects and in the illustrated construction, forwardly extending legs 58aF, 58bF of the carriage 56F define blade recesses (not shown) and the flanges are positioned in the blade recesses.

The frame 14G supports a cutting tool 78G having a cutting edge 80G and outwardly extending flanges 82aG, 82bG located on opposite sides of the cutting edge 80G. The flanges 82aG, 82bG define engagement surfaces 84aG, 84bG and apertures 85a, 85b. The flanges 82aG, 82bG support elastic members (e.g., springs) 87a, 87b in the apertures 85a, 85b. The elastic members 85a, 85b apply a force (represented by arrows F in FIGS. 14 and 15) and bias the cutting tool 78G outwardly from the frame 14G in a direction generally parallel to the second axis B. In other aspects and in other constructions (not shown), the cutting tool 78G can support one, three, or more elastic members 85.

During operation, as the carriage 56G is moved along the cutting path 57G (e.g., by a drive assembly, as described above with respect to the previously described first construction), the cutting edge 68G trims some of slats S of the blinds V. As the carriage 56G continues to move along the cutting path 57G, the final slats S are sheared between the cutting edge 68G of the cutting blade 64G and the cutting edge 80G of the cutting tool 78G. Additionally, the elastic members 87a, 87b force the cutting tool 78G outwardly in a direction generally parallel to the second axis B and maintain the cutting edge 80G of the cutting tool 78G in shearing engagement with the cutting edge 80G of the cutting blade 64G. In this manner, the elastic members 87a, 87b maintain a desired distance between cutting edges 64F and 80F during trimming of the slats S.

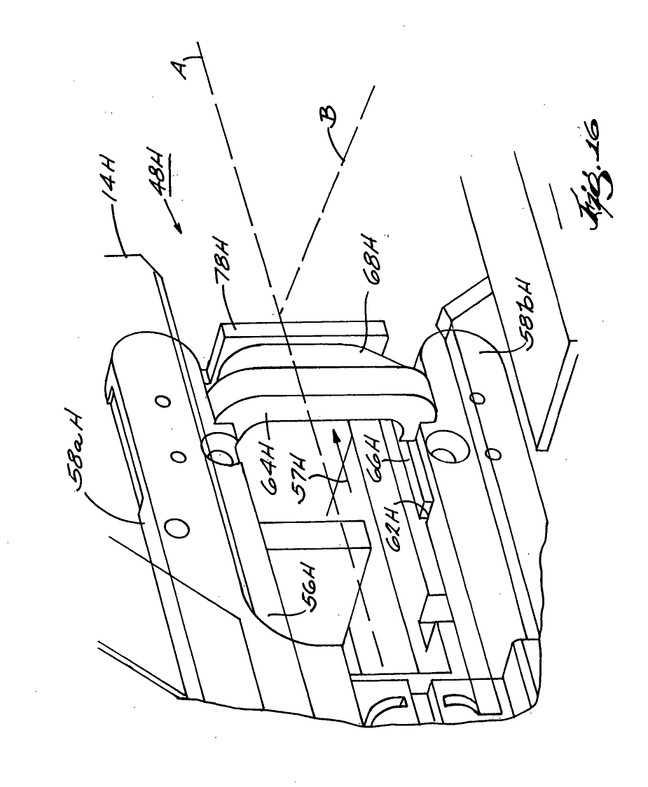

A seventh construction of a blade arrangement 48H for a blind trimming apparatus 10 is illustrated in FIG. 16. Common elements are identified by the same reference number “H”.

As shown in FIG. 16, a carriage 56H is moveable along a cutting path (represented by arrow 57H) which is substantially parallel to the first axis A. The carriage 56H is preferably coupled to a drive assembly (not shown) which is substantially similar to the above-described drive assemblies. The carriage 56H supports a cutting blade 64H, having flanges 66H (only one is shown in FIG. 16) and a cutting edge 68H extending between the flanges 66H. The cutting blade 64 is made of a first relatively hard material (e.g., machine steel, titanium, stainless steel, 1040 steel, 1060 steel, heat treated materials, alloys, composites, and the like) having a first hardness (e.g., having a Rockwell hardness number of between about 58 and about 62). In some aspects and in the illustrated construction, forwardly extending legs 58aH, 58bH of the carriage 56H define blade recesses 62H (only one is shown in FIG. 16) and the flanges 66H are positioned in the blade recesses 62H.

The frame 14H supports an anvil or cutting tool 78H made of a second relatively soft material (e.g., plastic, rubber, aluminum, brass, copper, and the like) having a second hardness (e.g., having a Rockwell hardness number between about 15 and about 50). In some aspects and in the illustrated construction, the cutting blade 64H is made of alloy tool steel having a Rockwell hardness number of about 60 and the cutting tool 78H is made of brass or another relatively soft materail having a Rockwell hardness number of less than about 50.

During operation, as the carriage 56H is moved along the cutting path 57H (e.g., by a drive assembly, as described above with respect to the previously described first construction), the cutting edge 68H of the cutting tool 64H shears the slats S against the cutting tool 78H. As the cutting tool 68H trims the final slats S, the cutting edge 68H of the cutting tool 64H impacts or dead ends against a front face of the relatively soft cutting tool 78H. Because the hardness of the cutting blade 68H is substantially greater than the hardness of the cutting tool 78H, the cutting edge 68H of the cutting tool 64H remains relatively sharp and is not dulled by repeated impacts with the front face of the cutting tool 78H.

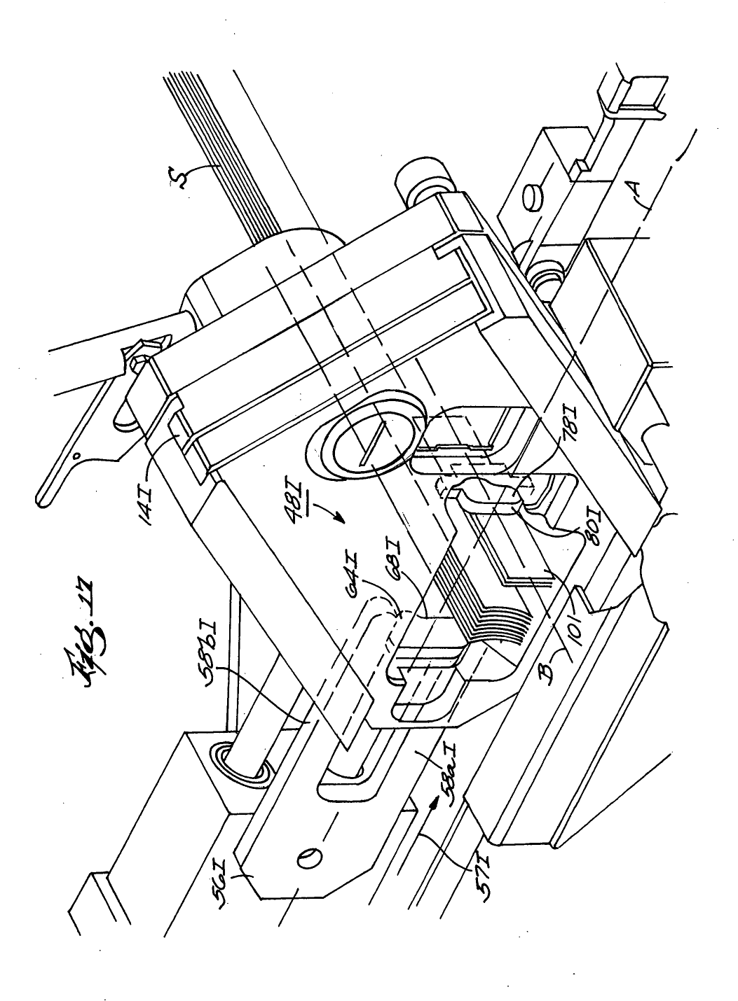

An eighth construction of a blade arrangement 48I for a blind trimming apparatus 10 is illustrated in FIG. 17. Common elements are identified by the same reference number “I”.

As shown in FIG. 17, a carriage 56I is moveable along a cutting path (represented by arrow 57I) which is substantially parallel to the first axis A. The carriage 56I is preferably coupled to a drive assembly (not shown) which is substantially similar to the above-described drive assemblies. The carriage 56I supports a cutting blade 64I, having flanges (not shown) and a cutting edge 68I extending between the flanges. Forwardly extending legs 58aI, 58bI of the carriage 56I define blade recesses (not shown) and the flanges are positioned in the blade recesses.

The frame 14I supports a cutting tool 78I having a cutting edge 80I that extends into a blind slat opening 22I along the second axis B. An insert 101 is positioned along the cutting path 57I adjacent to the cutting tool 78I. In some aspects and in the illustrated construction, the insert 101 includes a number of conventional blind slats similar to the blind slats S of the blind V. However, in other aspects and in other constructions (not shown), one or more other inserts can also or alternately be used.

During operation, as the carriage 56I is moved along the cutting path 57I (e.g., by a drive assembly, as described above with respect to the previously described first construction), the cutting edge 68I contacts and trims the slats S of the blinds V. As the carriage 56I continues to move along the cutting path 57I, the insert 101 supports the slats S and prevents the final slats S from bending (e.g., along the first axis A) during trimming.

The constructions and aspects described above and illustrated in the drawings are presented by way of example only and are not intended as a limitation upon the concepts and principles of the present invention. As such, it will be appreciated by one having ordinary skill in the art, that various changes in the elements and their configuration and arrangement are possible without departing from the spirit and scope of the present invention as set forth in the appended claims.

1. A blind trimming apparatus comprising:
a frame defining a cutting recess;
a cutting tool supported by the frame and extending into the cutting recess; and
a cutting blade supported by the frame and moveable across the cutting tool during trimming, one of the cutting blade and the cutting tool having a locating protrusion and an other of the cutting blade and the cutting tool defining a locating recess, the locating protrusion being engageable in the locating recess to index one of the cutting blade and the cutting tool with respect to the other of the cutting blade and the cutting tool.

2. The blind trimming apparatus of claim 1, wherein the cutting tool includes the locating protrusion, and wherein the cutting blade defines the locating recess.

3. The blind trimming apparatus of claim 1, wherein the cutting blade includes the locating protrusion, and wherein the cutting tool defines the locating recess.

4. The blind trimming apparatus of claim 1, wherein the frame defines an axis, and wherein the cutting blade is moveable along a cutting path during trimming, at least a portion of the cutting path being substantially parallel to the axis.

5. The blind trimming apparatus of claim 4, wherein the frame defines a second axis, the second axis extending through the cutting recess and being substantially perpendicular to the first axis, and wherein during indexing, the cutting blade is moveable along the second axis into engagement with the cutting tool.

6. The blind trimming apparatus of claim 5, wherein the frame defines a third axis extending through the cutting recess and being substantially perpendicular to the first axis and the second axis, and wherein during indexing, the cutting tool is moveable along the third axis.

7. The blind trimming apparatus of claim 4, wherein the frame defines a second axis, the second axis extending through the cutting recess and being substantially perpendicular to the first axis, and wherein during indexing, the cutting tool is moveable along the second axis into engagement with the cutting blade.

8. The blind trimming apparatus of claim 1, wherein the cutting tool is supported in the cutting recess for floating movement relative to the frame.

9. The blind trimming apparatus of claim 1, wherein the cutting blade includes a first cutting edge and the cutting tool includes a second cutting edge, and wherein during indexing the first cutting edge is spaced between about 0.000 inches and about 0.001 inches from the second cutting edge.

10. The blind trimming apparatus of claim 1, wherein the cutting tool defines an axis, and wherein the cutting blade includes an engaging surface, the engaging surface contacting the cutting tool to limit movement of the cutting blade in a direction substantially parallel to the axis and toward the cutting tool.

11. A blind trimming apparatus comprising:
a frame defining a cutting recess;
a cutting tool supported by the frame and extending into the cutting recess;
a cutting blade moveable across the cutting tool during trimming; and
an elastic member biasing one of the cutting blade and the cutting tool into shearing engagement with an other of the cutting blade and the cutting tool during trimming.

12. The blind trimming apparatus of claim 11, wherein the cutting blade includes a first cutting edge and the cutting tool includes a second cutting edge, and wherein when the cutting blade is in shearing engagement with the cutting tool, the first cutting edge is spaced between about 0.000 inches and about 0.001 inches from the second cutting edge.

13. The blind trimming apparatus of claim 11, wherein the cutting tool defines an axis, and wherein the cutting blade includes an engaging surface, the engaging surface contacting the cutting tool to limit movement of the cutting blade in a direction substantially parallel to the axis and toward the cutting tool.

14. The blind trimming apparatus of claim 11, further comprising a blade carriage supporting the cutting blade, and wherein the spring biases the blade carriage toward the cutting tool during trimming.

15. The blind trimming apparatus of claim 11, wherein the frame defines an axis, and wherein the cutting blade is moveable along a cutting path during trimming, at least a portion of the cutting path being substantially parallel to the axis.

16. The blind trimming apparatus of claim 15, wherein the frame defines a second axis, the second axis extending through the cutting recess and being substantially perpendicular to the first axis, and wherein when the elastic member biases the one of the cutting blade and the cutting tool into shearing engagement with the other of the cutting blade and the cutting tool, the one of the cutting blade and the cutting tool is moveable along the second axis into engagement with the other of the cutting blade and the cutting tool.

17. The blind trimming apparatus of claim 16, wherein the frame defines a third axis extending through the cutting recess and being substantially perpendicular to the first axis and the second axis, and wherein when the elastic member biases the one of the cutting blade and the cutting tool into shearing engagement with the other of the cutting blade and the cutting tool, the one of the cutting blade and the cutting tool is moveable along the third axis into engagement with the other of the cutting blade and the cutting tool.

18. A blind trimming apparatus comprising:
a frame defining a cutting recess and having a rail;
a carriage movable along the rail and supporting a cutting blade, the carriage being moveable along a cutting path, the cutting path being adjustable relative to the frame during trimming; and
a cutting tool extending into the cutting recess and being engageable with the cutting blade as the carriage moves along the cutting path.

19. The blind trimming apparatus of claim 18, wherein one of the cutting blade and the cutting tool includes a locating protrusion and an other of the cutting blade and the cutting tool defines a locating recess, the locating protrusion being engageable in the locating recess to adjust the cutting path during trimming.

20. The blind trimming apparatus of claim 18, further comprising an elastic member biasing one of the cutting blade and the cutting tool into shearing engagement with an other of the cutting blade and the cutting tool during trimming.

21. The blind trimming apparatus of claim 18, wherein the cutting tool defines an axis extending through the cutting recess and being substantially perpendicular to the cutting path, and wherein one of the cutting blade and the cutting tool includes an engaging surface, the engaging surface contacting an other of the cutting blade and the cutting tool to limit movement of the one of the cutting blade and the cutting tool along the axis.

22. A blind trimming apparatus comprising:
a frame defining a cutting recess;
a cutting tool supported by the frame and extending into the cutting recess, the first cutting tool having a first hardness; and
a cutting blade moveable across the cutting recess and engageable with the cutting tool during trimming to shear blinds against the cutting tool, the cutting blade having a second hardness, the second hardness being greater than the first hardness.

23. The blind trimming apparatus of claim 22, wherein the cutting blade includes a cutting edge and the cutting tool includes an engagement surface, and wherein during trimming, the cutting edge shears blinds against the engagement surface.

24. The blind trimming apparatus of claim 22, wherein the cutting tool includes an engagement surface, and wherein the cutting blade is moveable along a cutting path before dead ending in the engagement surface.

25. A blind trimming apparatus comprising:
a frame defining a cutting recess;
a cutting tool supported by the frame and extending into the cutting recess;
a cutting blade moveable along a cutting path and being engageable with the cutting tool during trimming to shear blinds against the cutting tool; and
an insert positioned along the cutting path to support blinds during shearing.

26. The blind trimming apparatus of claim 25, wherein the insert includes a plurality of blind slats.

27. The blind trimming apparatus of claim 25, wherein at least a portion of the insert is sheared between the cutting blade and the cutting tool during trimming.

28. The blind trimming apparatus of claim 25, further comprising an insert guide adjacent the cutting path and operable to position the insert along the cutting path.

29-31. (Cancelled).
